(19) United States
(12) Patent Application Publication
(10) Pub. No.: US 2014/0009101 A1
(43) Pub. Date: Jan. 9, 2014

(54) Electric Drive

(71) Applicant: Lothar Dietl, Aalen (DE)

(72) Inventor: Lothar Dietl, Aalen (DE)

(21) Appl. No.: 14/017,913

(22) Filed: Sep. 4, 2013

Related U.S. Application Data
(63) Continuation of application No. PCT/EP2011/071388, filed on Nov. 30, 2011.

(30) Foreign Application Priority Data
Mar. 4, 2011 (DE) 102011013885.4

(51) Int. Cl. H02P 23/00

(52) U.S. Cl. CPC H02P 23/004
USPC 318/724

(57) ABSTRACT

An electric drive is disclosed, in particular for a power tool, including a rotor, a stator, and a first coil arrangement, which is designed to drive the rotor by a first rotating field, and including a first motor control arrangement, which is designed to supply the first coil arrangement with electric current in order to generate a first rotating field. The stator has a second coil arrangement for generating a second rotating field. The second coil arrangement can be actuated and energized separately from the first coil arrangement so as to actuate the second coil arrangement in an arbitrary commutation sequence.

### BACKGROUND OF THE INVENTION

The invention relates to an electric drive, in particular for a power tool, comprising a rotor, a stationary stator, and a first coil arrangement, which is designed to drive the rotor by means of a first rotating field, and comprising a first motor control arrangement, which is designed to supply the first coil arrangement with electric current in order to generate a first rotating field, wherein the electric drive has a second coil arrangement for generating a second rotating field, which is fixedly associated to the first coil arrangement and is magnetically coupled to the first coil arrangement.

The invention further relates to a method for actuating an electric drive, in particular for a power tool, wherein the electric drive has a rotor and a stationary stator, wherein a first coil arrangement for generating a first rotating field is supplied with electric current by a motor control, wherein a second rotating field is generated by means of a second coil arrangement, which is fixedly associated with the first coil arrangement and is magnetically coupled, at least in part, to the first coil arrangement.

A drive of this type and a method of this type is known from DE 10 2007 040 725 A1. This electric machine has a permanently magnetically excited rotor and a stator comprising a plurality of windings, which is operable on the one hand with a lower speed and on the other hand with a higher speed. To this end, parts of the stator winding are disconnected or switched over between a series connection and a parallel connection of specific coil portions. This switchover is intended to cause a switchover between normal operation and what is known as field weakening operation with a higher speed range.

By means of an electric machine of this type, different speed ranges can be implemented. A disadvantage with this electric drive however is that the resistance of the coils changes as a result of the switchover and the current intensity in the windings thus varies greatly. The ohmic losses in the windings in field weakening operation thus multiply, whereby the efficiency of the electric machine varies greatly. Furthermore, operating modes of this type cannot be used in a sustained manner, since the electric drive may be thermally overloaded by the ohmic losses.

It is also known to control the speed of an electric drive, in particular of a polyphase machine, by varying the supply voltage. Here, the speed is fundamentally influenced directly by the supply voltage. The torque with a control of this type cannot be influenced accordingly, however.

An electric motor comprising a mechanical field weakening device is also known from DE 10 2006 030 986 A1, in which the stator is displaced relative to the rotor in the axial direction in order to reduce the influence of the permanent magnets on the windings and to thus achieve a field weakening.

A disadvantage here is that the mechanics for the relative displacement of the rotor and of the stator are technically complex and can only be switched over very slowly.

On this basis, the object of the present invention is to specify an improved electric drive, in which the torque delivered and/or the speed delivered can be changed with simple means.

### BRIEF SUMMARY OF THE INVENTION

According to one aspect of the invention, the second coil arrangement of the electric drive of the type mentioned in the introduction can be actuated and energized separately from the first coil arrangement so as to actuate the second coil arrangement in an arbitrary commutation sequence.

According to a further aspect of the invention a method of the type mentioned in the introduction is provided, wherein the second coil arrangement is actuated and energized separately from the first coil arrangement.

Within the meaning of the present invention, the fixed association of the two coil arrangements with one another means that they do not move relative to one another during operation of the electric drive. In other words, the coil arrangements are associated both with the stator or both with the rotor, for example.

The electric drive can therefore be brought into different operating modes in which rotating fields of different strength and directed in different directions can be generated by the two coil arrangements by means of electric switchover.

The rotating field can thus be brought into at least two states, in which different speeds and different torques with substantially constant power output can be implemented. As a result, the speed at constant phase voltage, that is to say the speed constant, can thus change electronically and simulate a gear characteristic.

The actuation of the second coil arrangement can thus cause a weakening or a strengthening of the rotating field depending on the direction of polarity, whereby the speed and the delivered torque can be varied electronically.

It is particularly preferable if the second coil arrangement can be energized in such a way that the second rotating field is directed oppositely to the first rotating field, at least in part, or the first and the second rotating field are at least directed in the same direction.

The respective magnetic fluxes are thus superimposed, whereby a field weakening or a field strengthening can be achieved.

In accordance with a development of the invention, the first coil arrangement has a first plurality of coil sets and the second coil arrangement has a second plurality of coil sets, wherein at least one of the coil sets of the first coil arrangement is magnetically coupled to one of the coil sets in the second coil arrangement.

In other words, at least one of the coil sets of the first coil arrangement and one of the coil sets of the second coil arrangement are magnetically coupled to one another, whereby the rotating field of the second coil arrangement can weaken or strengthen the rotating field of the first coil arrangement. A field weakening or a weakening of the electromotive force (EMF weakening) or a field strengthening can thus be achieved using simple means.

In a further development of the invention, the first and the second coil arrangement have an identical plurality of coil sets, which are each associated to one another and are each magnetically coupled to one another.

In other words, each of the coil sets of the first coil arrangement is associated with a coil set of the second coil arrangement, whereby the rotating field of each of the coil sets of the first coil arrangement can be weakened or intensified. A symmetrical and uniform field weakening or field strengthening is thus possible.

In a preferred embodiment, a plurality of coil sets of the first coil arrangement and a plurality of coil sets of the second coil arrangement can be energized simultaneously.

A multi-phase rotating field for driving the electric drive can thus be generated, whereby an effective drive can be provided.

Here, it is preferable if at least one coil set of the second coil arrangement can be energized, said coil set being associated with an unenergized coil set of the first coil arrangement.

Accordingly resultant total fields or differential fields can thus be generated, which have merely a low EMF weakening or a low field weakening, whereby further actuation variants with more finely graded characteristics can be provided.

It is also preferable if the first coil arrangement can be energized with a first plurality of phases and the second coil arrangement can be energized with a second plurality of phases.

In other words, the coil arrangements can be energized in a multi-phase manner, whereby a multi-phase A.C. machine can be produced.

It is also preferable if the first plurality of phases and the second plurality of phases are identical.

The first coil arrangement and the second coil arrangement can thus be actuated using identical controls.

It is also preferable if the first plurality of phases is greater than the second plurality of phases.

The second coil arrangement can thus be actuated more easily and with fewer components.

In accordance with a development, the first and the second coil arrangement each have three coil sets, which are each arranged in a star connection or a delta connection or are arranged in a star connection and a delta connection.

In other words, the first coil arrangement and the second coil arrangement are arranged in a star connection, or the first and the second coil arrangement are arranged in a delta connection, or the first coil arrangement is arranged in a star connection and the second coil arrangement is arranged in a delta connection or vice versa in order to generate corresponding rotating fields.

Different field weakenings can thus be generated depending on the application.

It is also preferable if the drive is formed as an electronically commutatable D.C. machine or permanent-magnet-excited synchronous machine, wherein the first and the second coil arrangement can be energized differently in a plurality of commutation steps.

The electric drive can thus be electrically controlled or regulated in different modes without the need to use additional mechanical elements or sliding contacts.

It is also preferable if the second coil arrangement can be energized in at least one of the commutation steps in such a way that the second rotating field is directed oppositely to the first rotating field.

A field weakening can thus be generated in individual commutation steps, whereby a multiplicity of different speed and torque characteristics can be produced.

It is also preferable if the second coil arrangement can be energized in at least one of the commutation steps in such a way that the second rotating field is directed in the same direction as the first rotating field.

In other words, the second coil arrangement can intensify and also weaken the present rotating field of the first coil arrangement in different commutation steps of a revolution of the rotor, such that an elliptical rotating field is produced as the resultant rotating field.

A multiplicity of different speed-torque characteristics can thus be produced, whereby the electric drive can be used in a versatile manner.

It is also preferable if the second coil arrangement can be actuated and energized with electric current by a second motor control arrangement.

In other words, the first coil arrangement is actuated and supplied with electric current by a first motor control arrangement, and the second coil arrangement is actuated and supplied with electric current by a second motor control arrangement. The two coil arrangements can thus be actuated and energized separately, whereby a multiplicity of independent actuation possibilities are produced.

It is also preferable if the first and the second coil arrangement can be energized by the same current.

In other words, the two motor control arrangements actuate the coil arrangements differently, wherein the motor control arrangements are supplied by the same current, which is conveyed through the two coil arrangements. The power output of the electric machine with different actuations thus remains constant, whereby the ohmic losses with the different actuation types remain substantially constant, for example.

In accordance with a development of the invention, the two motor control arrangements are designed to operate the motor with a first speed-torque characteristic and with a second speed-torque characteristic, which has a different gradient compared to the first speed-torque characteristic.

The relative load is to be considered in this case as the quotient from the difference in speed between no-load speed n_{L} and load speed n_{L} on the one hand and no-load speed n₀ on the other hand, that is to say

$$( 1 - \frac{{n}_{0}}{{n}_{L}} )$$

or alternatively as the quotient from load torque M_{L} and (with saturation or current limitation calculated from the offset coefficient) holding torque M_{H}, that is to say

$$\frac{{M}_{L}}{{M}_{H}} .$$

In this way, the behavior of the drive may have the functionality of a switchable gearing. A gear-related correlation, for example a step-up factor or a step-down factor or a spread, can be provided between the speeds or the torques of the first and the second characteristic.

In other words, when transitioning from the first characteristic to the second characteristic, the speed may increase by the factor by which the torque reduces.

In a development, the respective gradients of the speed-torque characteristics can be set in accordance with the directions of the first and of the second rotating field and/or in accordance with the sequence of the individual commutation steps.

In other words, the gradient of the speed-torque characteristics can be changed by the selective field weakening or strengthening or by the resultant elliptical rotating field, such that the polarity reversal of the coil arrangements in individual commutation steps enables a different step-up factor or a step-down factor or a spread between the speeds or the torques.

In an expedient embodiment of the invention, coil sets of the first coil arrangement associated to one another have a first number of windings z₁ and the second coil arrangement has a second number of windings z₂, wherein, in the event of energization by means of the motor control arrangements, a total field is produced if the corresponding rotating fields are directed in the same direction, and a differential field is produced if the corresponding rotating fields are directed in opposite directions.

The functionality of a multiple gear can thus be produced.

If the coil set of the first coil arrangement and the coil set of the second coil arrangement are identically polarized, a total number of windings m is given, which is identical to the sum of the first number of windings m₁ and the second number of windings z₂. The coil sets consequently behave similarly to an individual coil having m windings.

If the coil sets or coil arrangements are oppositely polarized, that is to say if the second rotating field works against the first rotating field, the flux coupled by means of the second coil portion works against the flux generated in the first coil portion. The associated magnetic fields and induced voltages are consequently cancelled out in part. As a result, an effective number of windings z*, which corresponds to the difference between the first number of windings m₁ and the second number of windings z₂, remains.

The factor f can be established from the ratio of the effective number of windings z* and the total number of windings z and represents a measure for the “transmission” of the speed that can be effected with the respective embodiment of the first coil portion and the second coil portion. The torque produced here can be specified similarly (that is to say in a manner inversely proportional thereto).

With this type of field neutralization or field weakening, both the power output P₂ (n is greater, M is smaller) and the ohmic losses remain substantially unchanged with constant relative load, such that the thermal design of the motor can take into account both states equally. The suitability for continuous operation thus improves considerably.

In accordance with a specific embodiment, the number of windings m₂ of the coil set of the second coil arrangement, which is coupled to the coil set of the first coil arrangement, is smaller than the number of windings m₁ of the first coil set. Depending on the number of windings that can be produced in practice, practically any arbitrary transmission ratio can thus be implemented. In this case, gearing up or gearing down can be implemented, for example when transitioning from a first characteristic to a second characteristic.

Since a multiplicity of speed-torque characteristics with different gradients can be set due to the large number of different combinations during the commutation steps, many “transmission ratios” can be implemented accordingly, such that the functionality of a multiple gear can be set.

It is particularly preferable if the drive is used in a power tool, in particular in a hand-held power tool supplied with independent electrical energy, that can be coupled to a tool spindle to drive the tool.

The power tool may be a tool for screwing, drilling, sawing, cutting, grinding or polishing.

Power tools of this type are used for a wide range of purposes, and it is therefore often desirable to influence an output motion of the tool, for example by varying the output torque or the output speed.

Such variations can be implemented with the aid of mechanical gear units, which may have a plurality of switching steps, which on the one hand can influence the output speed or the output torque and on the other hand can also influence a direction of rotation, for example. Here, in the case of mechanical gear units, in particular in the case of gearings, each transmission step is generally associated with a constant transmission f.

In accordance with the present invention, a characteristic of this type can also be effected directly with the drive, such that a gear unit of this type can be replaced or supplemented by an extended functionality.

A particular advantage of the invention is that the switchover can occur under load. The mechanical drivetrain is unchanged here. The position of the switchover point can be selected freely. In contrast, in the case of a mechanical gear unit, a switchover generally has to be implemented during standstill. In addition, a switchover element has to be mechanically moved.

A power tool that can be switched over in accordance with the invention can therefore be constructed in a particularly simple manner, but at the same time can cover a broad spectrum of use.

Here, the motor control arrangements can be designed to detect an operating state variable or to evaluate an operating state variable fed to them so as to actuate the coil arrangements differently according to said variable.

If, for example, it is determined that, due to a high relative load, there is a drop in speed, one of the coil arrangements could thus be actuated for example in order to effect a generally higher output torque.

If, by contrast, it is determined that only a low relative load is applied, the coil arrangements can thus be actuated such that a high-speed step is implemented, for example in the case of a screwdriver.

The performance of the power tool can thus be increased on the whole, and the power tool can be used in a more versatile manner.

In accordance with a specific embodiment of the invention, the motor control arrangements for actuating the first and the second coil arrangement are coupled to one another in such a way that the same current flows through both coil arrangements. Here, the motor control arrangements each have three parallel current paths, each with two controllable switches, between which taps for the respective phases of the coil arrangements are formed. The two coil arrangements can thus be actuated separately, wherein the power consumption is substantially constant, since the same current flows through the two coil arrangements. In a particular embodiment, the controllable switches are formed by semiconductor switching elements. Rapid switching in accordance with the commutation speed is thus possible.

In accordance with a further embodiment of the invention, the power tool has an energy supply unit for providing electrical energy, which can preferably be coupled to a D.C. source and more preferably to an accumulator.

In particular in the case of independent and preferably portable power tools, a variation of the speed-torque characteristic contributing to an improvement of the performance of the power tool can therefore be implemented without significant additional weight.

In the case of a power tool that has a permanently excited electronically commutatable electric motor, the motor control of which is coupled to a D.C. source, the drive according to the invention can be implemented particularly easily with a rather low number of additionally necessary components.

On the whole, a novel drive is provided by the invention, which in particular is suitable for a power tool and can simulate a “gear functionality” to a large extent. Here, a multiplicity of speed-torque combinations can be implemented.

This simulation of the gear functionality is implemented with high efficiency and with the avoidance of wear-inducing states of the drive, in particular in view of the thermal load caused by ohmic losses.

The drive according to the invention can also be used in principle as an electric machine, for example in a generator application.

It goes without saying that the above-mentioned features and the features yet to be explained hereinafter can be used not only in the respective specified combinations, but also in other combinations or in isolation without departing from the scope of the present invention.

### BRIEF DESCRIPTION OF THE SEVERAL VIEWS OF THE DRAWING

Exemplary embodiments of the invention are illustrated in the drawing and will be explained in the following description. In the drawing:

FIG. 1 shows a schematic view of a power tool with a drive according to the invention;

FIG. 2 shows a schematic illustration of a drive according to the invention with an iron core and two independent coil arrangements;

FIG. 3 shows a simplified circuit diagram of the drive with two independent actuation arrangements;

FIG. 4a-h show different actuation modes of the coil arrangements for generating a field strengthening or a field weakening;

FIG. 5 shows six commutation steps of an electronically commutatable D.C. machine with a coil arrangement;

FIG. 6a-f show different variants of possible commutation sequences;

FIG. 7 shows an idealized speed-torque characteristic for two different actuation states;

FIG. 8 shows a simplified schematic circuit diagram of an actuation unit for actuating two coil arrangements in star connection;

FIG. 9 shows a simplified schematic circuit diagram of an actuating unit for actuating two coil arrangements in delta connection;

FIG. 10 shows a table for explaining possible switching states of the control unit from FIGS. 8 and 9 for actuating two coil arrangements of an electric machine in normal operation;

FIG. 11a, b show two tables for explaining possible switching states of the control unit from FIGS. 8 and 9 for actuating two coil arrangements in EMF weakening operation for six different commutation steps in each case.

### DETAILED DESCRIPTION OF THE INVENTION

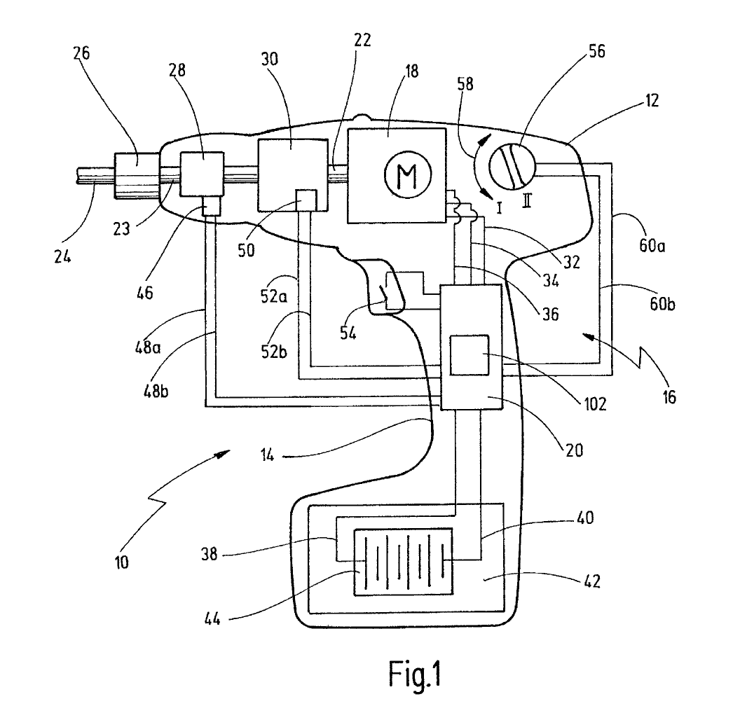

FIG. 1 shows a simplified schematic illustration of a power tool, which is denoted on the whole by 10.

By way of example, the power tool 10 is illustrated as a tool for drilling or screwing. It goes without saying that it may also be a tool for impact drilling, impact screwing, sawing, hammering, cutting, grinding or polishing, for example.

Depending on the purpose, the output motion here can be linear, rotary, intermittent or oscillating. In the present case, the power tool 10 has a housing 12 with a grip region 14, at which an operator can grip and actuate the power tool 10.

In or on the housing 12, a drive 16 is provided that has a motor 18 and a motor control 20. The motor 18 is used to drive a motor shaft 22, which is coupled to a tool spindle 23, which cooperates with a tool 24 (illustrated merely in a broken manner).

The tool 24 is fixed via a tool receptacle 26, for example a chuck, to the tool spindle 23.

A clutch 28 or a gear unit 30 can be arranged between the tool spindle 23 and the motor shaft 22. The gear unit 30 can be formed for example as a gearing and may have a constant transmission or a number of switchable transmission steps. The clutch 28 can be formed for example as a slip clutch or as a shift clutch and can be used for overload protection or can separate the tool spindle 23 from the motor shaft 22 within the scope of a no-load functionality. Furthermore, the clutch 28 may have a stop function for example, that is to say it may be fixable with respect to the housing 12 in order to allow a simple tool change or the like.

The motor 18 is preferably formed as a permanently excited electrically commutatable electric motor, also referred to as an EC motor. Here, the motor control 20 can actuate the motor 18 to generate a rotating field. For this purpose, the motor control 20 is connected via electrical lines 32, 34, 36 to the motor 18.

The motor control 20 can also be coupled via supply lines 38, 40 to a power supply device 42, which is formed by way of example in FIG. 1 as an accumulator 44.

The accumulator 44 is used here as a direct current source, and the source voltage is converted by the motor control 20 into a voltage that is applied to the motor 18 via the electrical lines 32, 34, 36. Here, each of the lines 32, 34, 36 can be assigned a phase U, V, W, for example.

Alternatively, the power tool 10 can also be connected to a stationary voltage source, for example mains. To convert an A.C. voltage into a D.C. voltage, an inverter arrangement can be provided here.

In FIG. 1, the motor control 20 is also coupled by way of example to sensors 46, 50; here, a signal transmission is implemented via sensor lines 48a, 48b and 52a, 52b. The sensors 46, 50 can be designed to detect an operating state variable for describing an operating state of the power tool 10 and for transmitting this variable to the motor control 20 or a control device provided with the motor control or coupled thereto.

Here, the operating state variable to be detected can, in principle, be a speed or a torque, for example at the drive or at the output, a switching state of a switch, a temperature, for example of the gear unit 30 or of the accumulator 44, or a value that embodies a voltage applied to the lines 32, 34, 36 or a current flowing through said lines.

The sensor 46 can be designed for example to detect a switching state of the clutch 28. Alternatively, the sensor 46 could be designed for example to detect a temperature at the clutch 28 as an indicator of wear or load.

The sensor 50 may also be intended to detect a switching state, for example a currently selected switched position, of the gear unit 30 or to detect a temperature characterizing a momentary loading.

In the grip region 14 of the power tool 10, an actuation switch 54 is also provided, via which the operator can selectively activate or deactivate the power tool 10. The actuation switch 54 is also coupled to the motor control 20.

Furthermore, a selecting switch 56 is provided on the housing 12 of the power tool 10 and is coupled via selecting switch lines 60a, 60b to the motor control 20. The selecting switch 56 can be switched back and forth between a first position and a second position, as indicated by an arrow denoted by 58. Via the selecting switch 56, the operator can switch the drive 16 of the power tool 10 between a first state having a first speed-torque characteristic and a second state having a second speed-torque characteristic, for example.

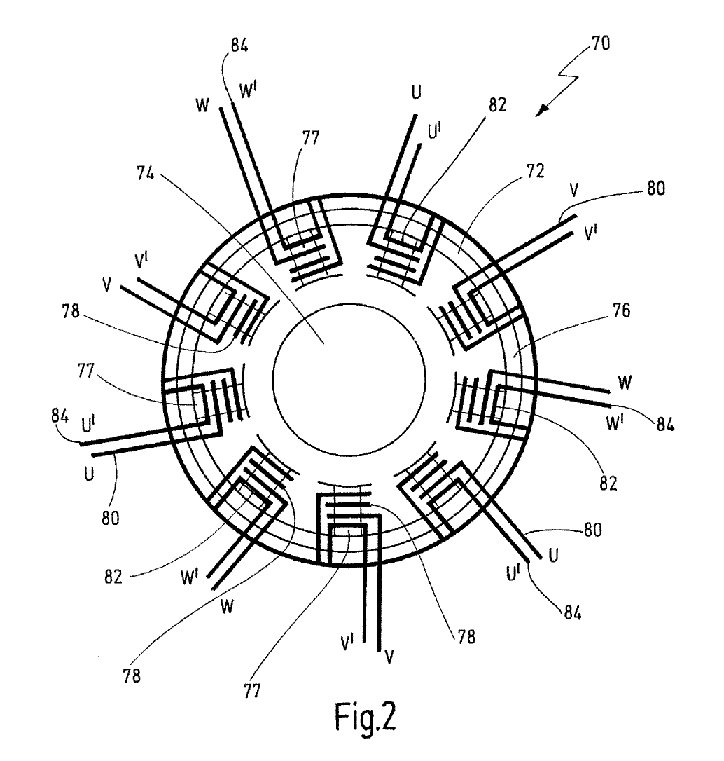

A drive according to the invention is illustrated schematically in FIG. 2.

The electric drive is denoted generally by 70 in FIG. 2. The electric drive 70 has a stator 72 and a rotor 74. The stator 72 has an iron ring 76 with radial iron core portions 77, on each of which a coil 78 is arranged. The stator 74 in this case has nine coils 78, which are supplied with electrical power via electrical lines 80. The lines 80 connect the coils 78 to three phases U, V, W. In the present case, three of the coils 78 are in each case connected in parallel and form a coil set, wherein the resultant three coil sets are connected together in a star connection.

The coils 78 generate a magnetic rotating field, which acts on the permanent-magnetic rotor 74 and drives it in a drive direction. Due to an alternating actuation of the coil sets via the phases U, V, W, a rotating field is generated that drives the permanent-magnetic rotor 74 accordingly.

An additional coil 82 is also arranged on each of the radially oriented iron cores 77 and is connected by means of electrical lines 84 and can be energized with electric current by three phases U′, V′, W′. The coils 78 and the additional coils 82 are each magnetically coupled to one another via the iron core portions 77. The additional coils 82 generate a second magnetic rotating field, which acts on the permanent-magnetic rotor 74. The first magnetic rotating field, which is generated by the coils 78, and the second magnetic rotating field, which is generated by the additional coils 82, are superimposed, such that, depending on the direction of the two rotating fields, a total field is produced that is greater than the respective individual rotating fields, or a differential field is produced that is smaller than one of the rotating fields. Here, the magnetic fluxes of the first rotating field and of the second rotating field are added together and form a magnetic total flux. The additional coils 82, depending on the direction of their actuation, can thus cause a field weakening (EMF weakening) or a field strengthening. The additional coils 82 are in this case connected together in a star connection, similarly to the coils 78, to form three coil sets and can thus be supplied with electric current via the phases U′, V′, W′ such that a rotating field is produced.

The coils 78 each have a number of windings z₁ and the additional coils each have a number of windings m₂. The number of windings z₂ is preferably smaller than the number of windings z₁. It is preferable if the ratio of the number of windings z₁:z₂ is less than 1:2. In a particular embodiment, the ratio is less than 1:3 or less than 1:4. In an alternative embodiment, the number of windings z₁, z₂ is identical.

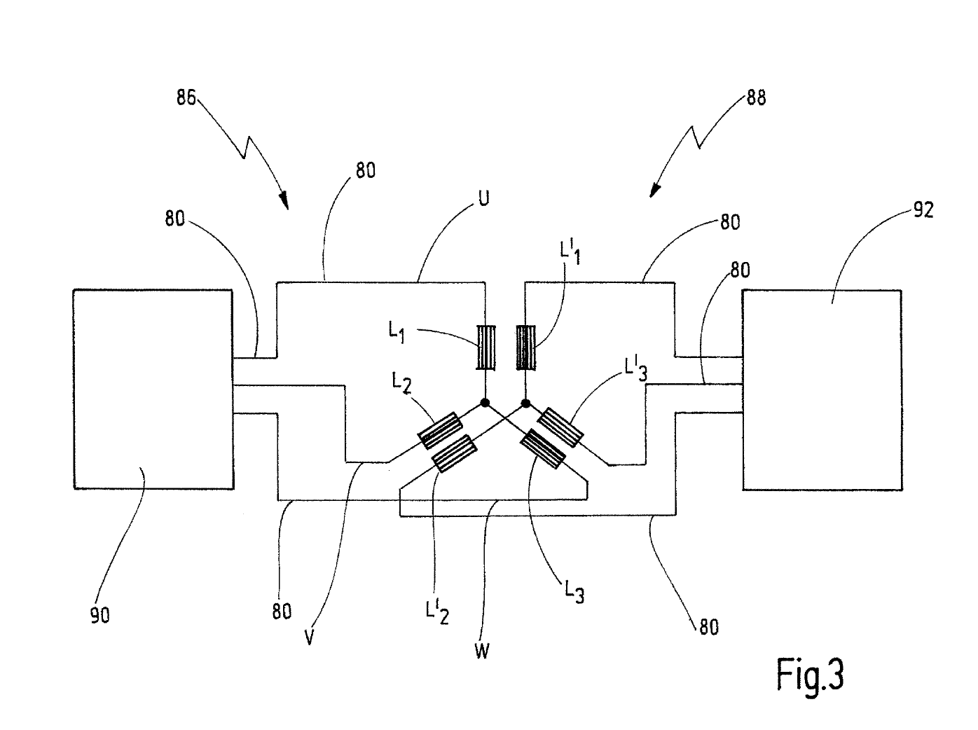

In FIG. 3, a schematic circuit diagram of the electric drive 70 is shown. Here, merely coil sets of two independent coil arrangements 86, 88 are illustrated, wherein the coil sets of the first coil arrangement 86 are denoted here in general by L₁, L₂, L₃ and the coil sets of the second coil arrangement 88 are denoted here in general by L₁′, L₂′, L₃′. The respective coil sets L₁, L₁′ and L₂, L₂′ and L₃, L₃′ are associated with one another in each case and are magnetically coupled to one another as illustrated in FIG. 2. The coil sets L₁, L₂, L₃ are supplied with electrical power via the phases U, V, W. The coil sets L₁, L₂, L₃ are connected via the lines 80 to an actuation unit 90. The coil sets L₁′, L₂′, L₃′ are supplied with electrical power via the phases U′, V′, W′. The coil sets of the second coil arrangement 88 are connected via the lines 80 with a second actuation arrangement 92. The actuation arrangements 90, 92 supply the coil arrangements 86, 88 independently with electrical power, such that independent rotating fields can be generated that are superimposed additively or subtractively depending on the actuation.

An electric drive 70 is thus provided by means of two coil arrangements 86, 88 and two actuation arrangements 90, 92, which causes a field weakening or what is known as a weakening of the electromotive force (EMF weakening) or a field strengthening depending on the actuation and can thus generate different speeds with different torques.

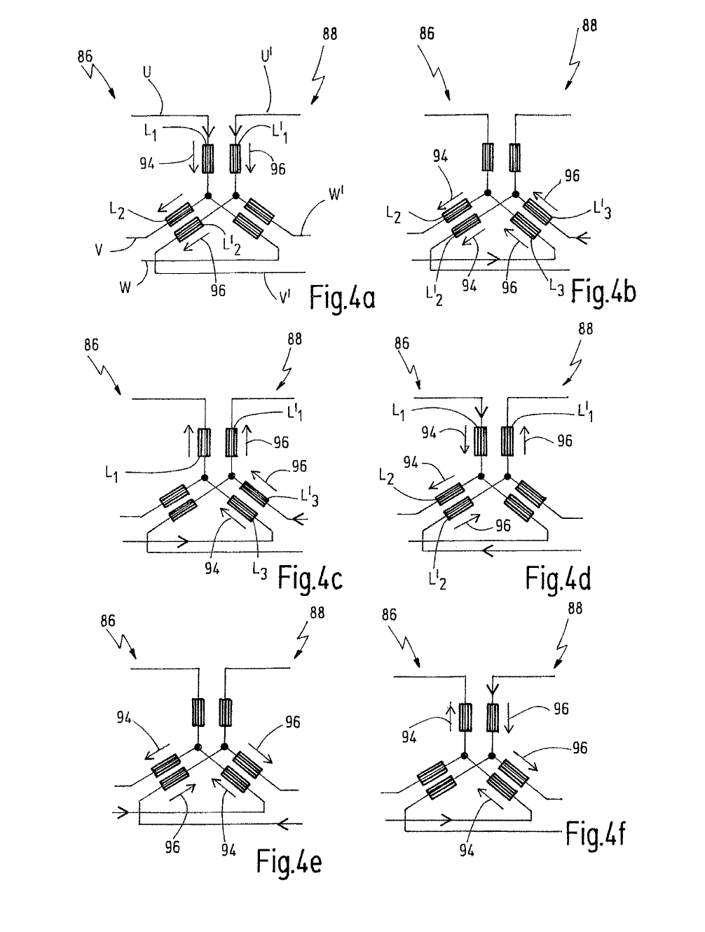

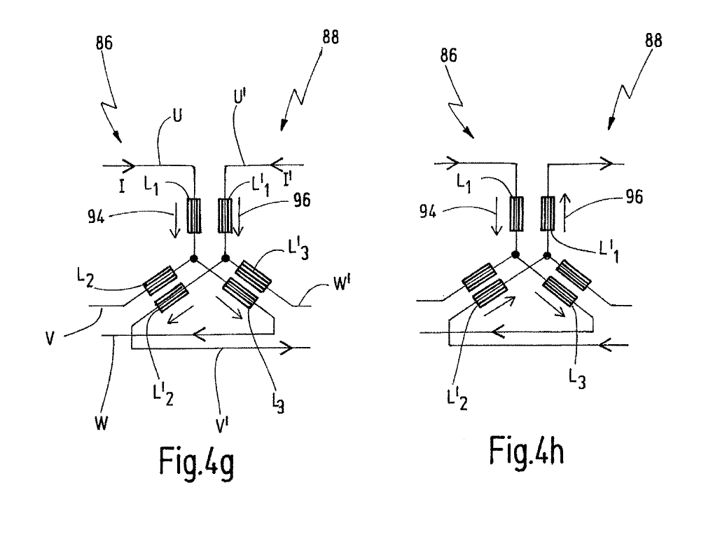

Various switched or excitation states or polarizations of the coil sets L₁ to L₃ and L₁′ to L₃′ are illustrated in FIGS. 4a to 4h. The coil arrangements 86, 88 are identical to the coil arrangements 86, 88 illustrated in FIG. 3. Like elements are provided with like reference signs, wherein merely the differences are presented here. In FIG. 4a, the coil arrangements 86, 88 are actuated or energized via the phases U, V and U′, V′ in such a way that the coil sets L₁ and L₁′ and also L₂ and L₂′ generate rotating fields 94, 96 in the same direction, such that a reinforced total field is produced.

In FIG. 4b, the coil arrangements 86, 88 are actuated via the phases V, W and V′, W′ in such a way that the coil sets L₂, L₂′ and L₃, L₃′ generate a rotating field 94, 96 respectively which is oriented in the same direction, such that they are added together to form the total field.

In FIG. 4c, a further actuation state of the coil arrangements 86, 88 is illustrated, in which the rotating fields 94, 96 generated by the coil sets L₁, L₁′ and L₂, L₂′ are added together to form an intensified total field.

It goes without saying that the states illustrated in FIGS. 4a to 4c can also each be generated in the opposite direction.

In FIGS. 4d to 4f, three different actuation states of the coil arrangements 86, 88 are illustrated by way of example, in which the rotating fields 94, 96 are oppositely directed, such that the rotating field 96 of the second coil arrangement weakens the rotating field 94 of the first coil arrangement. Here, a differential field is produced. In FIG. 4d, the coil arrangements 86, 88 are actuated in such a way that the coil sets L₁ and L₂ generate the rotating field 94, wherein the second coil arrangement 88 is actuated in such a way that the corresponding coil sets L₁′, L₂′ generate the rotating field 96, which is directed oppositely to the rotating field 94. The rotating field 96 can thus weaken the rotating field 94, and the differential field can be formed.

In FIGS. 4e and f, further switching states are illustrated, in which the rotating field 96 is directed oppositely to the rotating field 94.

In FIG. 4g, an actuation state of the coil arrangements 86, 88 is illustrated by way of example, in which the coil arrangements 86, 88 are energized in such a way that the coil sets L₁ and L₁′, which are magnetically coupled to one another, are energized, and in such a way that the coil sets L₂′ and L₃, which are not magnetically coupled to one another, are also energized. The rotating fields 94, 96 are thus superimposed merely in part. A further variant of the actuation of the coil arrangements 86, 88 can thus be achieved, in which a resultant total field is produced, of which the amount is less than the amount of the total fields produced in FIGS. 4a to 4c.

In FIG. 4h, a further actuation state of the coil arrangements 86, 88 is illustrated by way of example, in which the rotating fields 94, 96 of two magnetically coupled coil sets are oppositely directed. The coil arrangements 86, 88 are energized in such a way that the rotating field 94 of the coil set L₁ is directed oppositely to the rotating field 96 of the coil set L₁′, and in such a way that two further coil sets L₂′, L₃, which are not magnetically coupled to one another, are energized. A differential field is thus produced which differs from the differential fields from FIGS. 4d to 4f. Further variants of the actuation of the coil arrangement 86, 88 can thus be provided.

It goes without saying that the switching states illustrated in FIGS. 4d to 4h can also each be implemented in the opposite direction of polarization of the coil arrangements 86, 88.

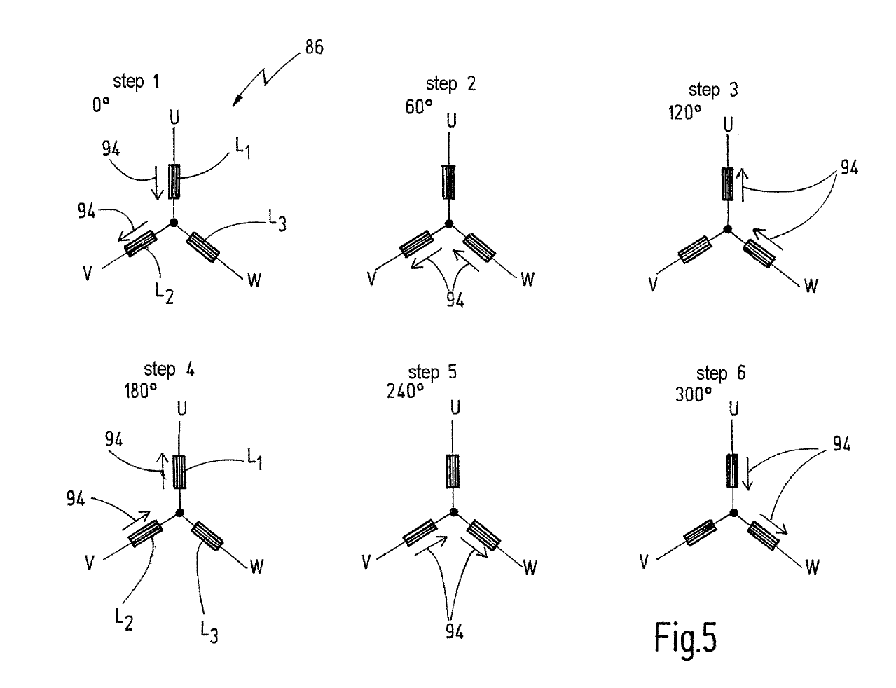

In FIG. 5, six commutation steps of an electric polyphase machine are illustrated, for example illustrating how the first coil arrangement 86 is actuated during operation via the phases U, V, W.

By way of example, a system having the three phases U, V, W is illustrated here with three coil groups adapted to the numbers of poles or the number of phases. The coil groups are each formed from two coil sets L₁, L₂, L₃ actuated simultaneously. The coil groups consisting of the coil sets L₁, L₂ or L₂, L₃ or L₁, L₃ are thus energized depending on the actuation. These coil groups are also referred to as commutation groups. The three possible commutation groups can each be energized in two current directions, wherein one of the commutation groups with the respective current direction is referred to as a commutation step. In the system illustrated here by way of example, there are thus six commutation steps. The order in which the six commutation steps are carried out defines a complete commutation sequence. Normally, the three commutation groups are initially energized with the same current direction, wherein the direction of rotation of the rotor is fixed by the order. These three commutation groups or commutation steps correspond to steps 1 to 3 from FIG. 5. The commutation steps are then carried out in the same order with opposite current direction. These commutation steps correspond to steps 4 to 6 from FIG. 5. The sequence thus described of commutation steps is referred to generally as the basic state.

The rotating field 94 is generated in rotating form via the six steps illustrated in FIG. 5 in order to drive the permanent-magnetic rotor 74. With this so-called block commutation, specific coil groups are energized in accordance with the rotation position of the rotor 74 in order to generate the rotating field 94 at specific angular positions of the stator 72 and to drive the rotor 74 accordingly. With this block commutation, a coil group or commutation group, that is to say two of the three coil sets L₁, L₂, L₃, are each energized in such a way that the rotating field 94 rotates about the rotor 74 in order to drive it accordingly, as described above. In FIG. 5, six commutation steps are illustrated, more specifically in accordance with the angular position of the rotor 74. It goes without saying that with other coil arrangements another number of block commutation steps is possible. With the six commutation steps illustrated in FIG. 5, one commutation group in each case, that is to say two of the coil sets L₁, L₂, L₃, is energized, more specifically either in a first direction or in the opposite, second direction depending on the step. In other words, the coil sets L₁ and L₂ in step 1 are poled at 0° in the first direction, and in step 4 at 180° the coil sets L₁, L₂ are poled in the opposite, second direction. The same is true for steps 2 and 5 and also 3 and 6 accordingly.

In an identical manner, the coil arrangement 88 is also energized, such that, with each individual commutation step, corresponding coil groups are actuated such that the two rotating fields 94, 96 act or can be oriented in the same direction or in opposite directions depending on the current direction, as is shown in FIGS. 4a-f. Different total fields or differential fields can thus be generated in each individual one of the commutation steps, whereby symmetrical or asymmetrical elliptical rotating fields can be generated. Alternatively, different coil groups can also be actuated or energized in one commutation step, as is shown in FIGS. 4g and 4h.

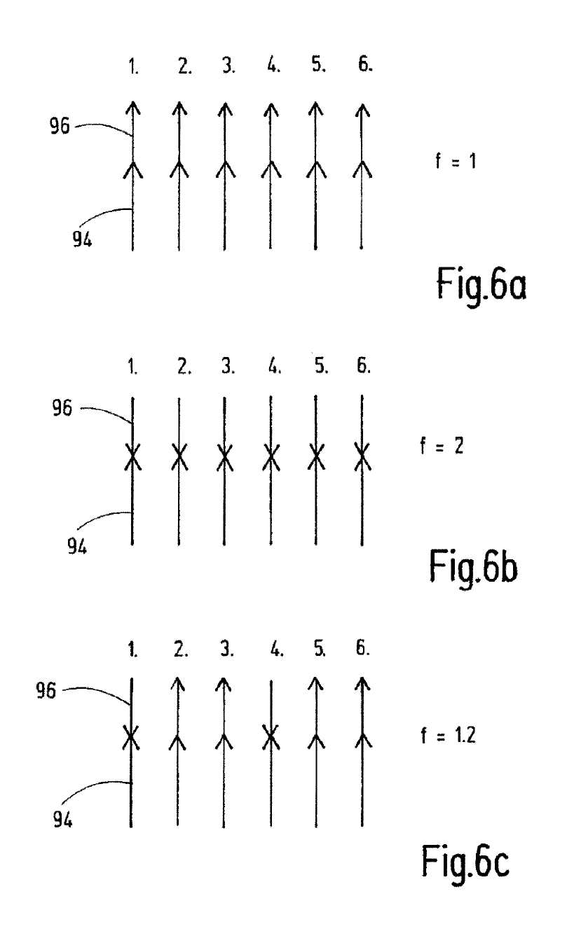

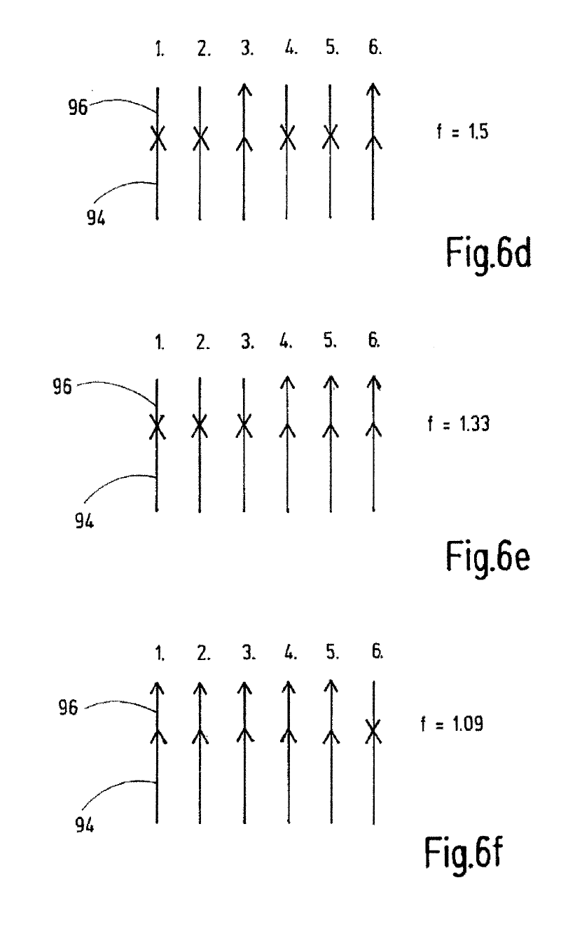

Different commutation sequences of the electric drive 70 are shown in FIGS. 6a to f, in which both the coil arrangement 86 and the coil arrangement 88 is actuated. In FIGS. 6a to f, the rotating field 94, which is generated by the first coil arrangement 86, and the rotating field 96, which is generated by the coil arrangement 88, are illustrated schematically by arrows. The polarization of the corresponding rotating fields 94, 96 is indicated by the direction of the arrows, wherein the direction pointing upwardly represents the drive direction of the rotor 74, and the direction pointing downwardly represents a rotating field against the drive direction. The six individual commutation steps from FIG. 6 are illustrated side by side and are denoted with corresponding numerals. For each of the commutation sequences illustrated in FIG. 6a to FIG. 6f, a weakening factor f is specified, which has been determined for a ratio of the number of windings of the coil arrangements 86, 88 of 1:3. The weakening factor can be determined by the following formula:

$$f = \frac{{H}_{A 1} \cdot {z}_{1} + {H}_{A 2} \cdot {z}_{2} + {H}_{B 2} \cdot {z}_{2}}{{H}_{A 1} \cdot {z}_{1} + {H}_{A 2} \cdot {z}_{2} - {H}_{B 2} \cdot {z}_{2}} ,$$

wherein H_{A1} is the number of commutation steps in which the first rotating field 94 is poled in the drive direction, H_{A2} is the number of commutation steps in which the second rotating field 96 is poled in the drive direction, and H_{B2} is the number of commutation steps in which the second rotating field is poled against the drive direction. z₁ and z₂ are the numbers of windings of the first and second coil arrangement 86, 88.

In FIG. 6a, an intensified state of all of the commutation steps 1 to 6 is illustrated. Here, the rotating fields 94, 96 in each of the commutation steps 1-6 are poled in the drive direction, such that a field intensification, that is to say an increased total field, is generated with each of the commutation steps 1-6, such that the rotor 74 is driven with an intensified symmetrical, not elliptical, rotating field. In this case, there is no field weakening of the rotating field 94. The weakening factor is f=1.

In FIG. 6b, a normal state of reverse polarity is illustrated, in which the rotating field 96 is directed oppositely to the rotating field 94 in each of the commutation steps 1-6. This normal state of reverse polarity is achieved since the second coil arrangement 88 is poled in a direction opposite to the first coil arrangement 86 in each of the commutation steps. With this normal state of reverse polarity, afield weakening factor of f=2 is achieved.

In the following figures, possible states of reverse polarity are illustrated, in which the second coil arrangement 86, 88 is poled against the drive direction in just some individual commutation steps.

In FIG. 6c, a commutation sequence is illustrated in which the rotating field 96 is poled merely in the first and fourth commutation steps against the drive direction, and is poled in the drive direction in the remaining commutation steps 2, 3 and 5, 6. The rotating field 94 is thus weakened merely in the first and fourth commutation step and is strengthened in the remaining commutation steps. An elliptical rotating field is thus produced. Since the commutation steps for the first half wave, that is to say commutation steps 1 to 3, are identical to those of the second half wave, that is to say commutation steps 4 to 6, a symmetrical elliptical rotating field is produced. In the commutation sequence illustrated in FIG. 6c, a field weakening factor of f=1.2 is produced.

In FIG. 6d, a commutation sequence is illustrated in which the rotating field 94 is oriented in each of the commutation steps in the drive direction and the rotating field 96 of the coil arrangement 88 is directed against the drive direction in steps 1, 2, 4 and 5. In the remaining commutation steps, the rotating field 96 is directed in the drive direction. A further possibility of an elliptical rotating field is thus provided. A state of reverse polarity of this type in this case causes a weakening factor of f=1.5.

Besides the symmetrical rotating fields, in which the first half wave, that is to say commutation steps 1 to 3, and the second half wave, that is to say commutation steps 4 to 6, are commutated identically, asymmetrical elliptical rotating fields are also possible, in which the first half wave is not commutated identically to the second half wave. By way of example, a commutation sequence for an asymmetrical elliptical rotating field is illustrated in FIG. 6e. Here, the rotating field 96 of the second coil arrangement 88 in the entire first half wave, that is to say commutation steps 1 to 3, is poled against the drive direction, wherein the rotating field 96 in the second half wave, that is to say the commutation steps 4 to 6, is poled in the direction of the drive direction. In the case of the commutation sequence from FIG. 6e, the rotating field 94 of the first coil arrangement 86 is poled in the drive direction in all commutation steps. Due to this commutation sequence, a weakening factor of f=1.33 can be achieved.

In FIG. 6f, a further possible commutation sequence for generating an asymmetrical elliptical rotating field is illustrated, wherein merely in step 6 is the rotating field 96 of the second coil arrangement 88 poled in the opposite direction. The minimum possible field weakening factor of f=1.09 can thus be achieved.

From the examples for commutation sequences in FIGS. 6a to f, it is clear that any desired polarization of the coil arrangements 86, 88 of the individual commutation steps is possible. Purely theoretically due to the six different commutation steps, wherein the coil arrangement 88 can adopt two states, are 2⁶=64 switching states possible.

Due to the different polarization of the coil arrangements 86, 88 in the various commutation steps, many different weakening factors f can be achieved, as illustrated by way of example in FIGS. 6a to f, whereby a corresponding number of different gradients of the speed-torque line can be achieved. The functionality of a gear unit can thus be simulated electrically, wherein the number of speeds corresponds to the different numbers of weakening factors. For this reason, many different speed-like transmission states can be implemented, as will be explained in greater detail hereinafter.

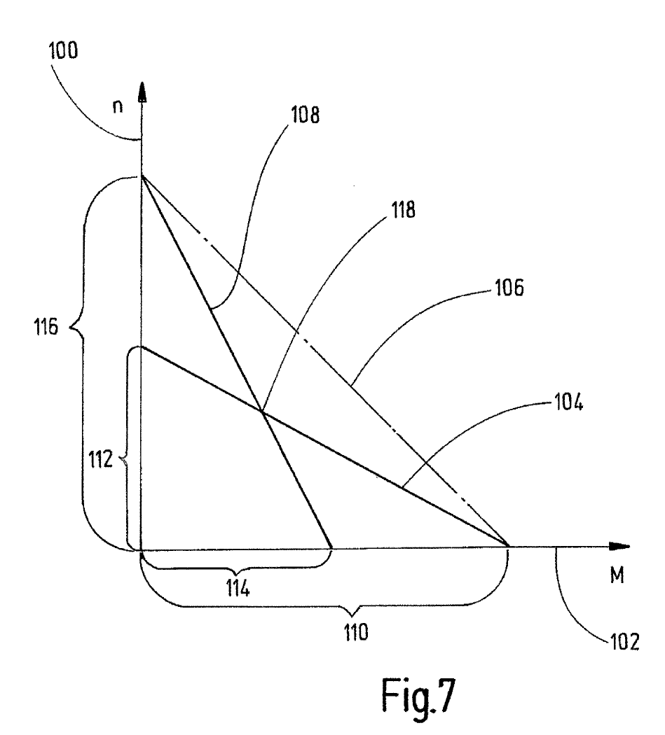

In FIG. 7, speed-torque characteristics of an electric motor are illustrated by way of example. Here, the speed n is plotted on the ordinate 100. By contrast, the abscissa 102 shows the values of the torque M.

Various speed-torque curves are plotted in an idealized manner by 104, 106 and 108, and the speed-torque characteristic 104 represents an n(M) curve of a typical electrically commutated rotating field motor by way of example. The drive 70 according to the invention can be operated in different states, which for example is described with a speed-torque characteristic 104 and with a speed-torque characteristic 108. Here, a functionality similar to a variable gear is caused by the different torques at different speeds. In FIG. 7, merely the two characteristics 104, 108 are illustrated as possible characteristics of the drive according to the invention, wherein a large number of characteristics with different gradients may be provided as described beforehand.

The first characteristic 104 is characterized by a holding torque 110 and a no-load speed 112. By contrast, the drive 70 can be operated in a further state, which is described by the characteristic 108, as if a step-up gearing with a step-up factor i=2 were inserted. The characteristic 108 is characterized by the holding torque 114 and the no-load speed 116. It is quite clear that, in the selected example, the no-load speed 116 is twice the no-load speed 112, for example. In contrast thereto, the holding torque 114 corresponding to the characteristic 108 is half the holding torque 110 of the characteristic 104. Considered in an idealized manner, the quotient of the holding torque 110 and of the holding torque 114 is inversely proportional here to the quotient of the no-load speed 112 and the no-load speed 116.

Numeral 118 specifies the point of intersection of the two characteristics 104, 108. If, at this point, there is a switchover between the two characteristics, this is fully imperceptible for the user. Proceeding from there, it is possible to continue with either the characteristic 104 or 108. Proceeding from the basis that a large number of different weakening factors and the associated different speed-torque characteristics can be implemented with different gradients, and the concept that it is possible to switch over from two speed-torque characteristics in a respective point of intersection, a linear (in portions) transmission ratio can indeed be produced, but appears to constitute a continuous change of the transmission ratio due to the large number of different gradients.

For comparison, a further speed-torque characteristic is indicated by 106, which in accordance with the prior art, for example in accordance with DE 10 2007 040 725 A1, can be produced starting from the characteristic 104.

Here, the transition from the characteristic 104 to the characteristic 106 can be implemented for example by switching off coil sections. Similarly to the characteristic 108 for example, the resultant characteristic 106 cannot be derived from no-load speed and holding torque whilst maintaining the inverse proportionality of the respective quotient.

Operation according to the characteristic 106 for example can be implemented here in principle by actuating just one of the coil arrangements 86, 88, for example.

In principle, the power output of the electric drive 70 in the state of the characteristic 104 or the characteristic 108 is substantially the same, since the product n M is identical with both characteristics. This output power is substantially the same irrespective of iron and friction losses, that is to say exclusively in consideration of ohmic losses, provided the relative load is identical.

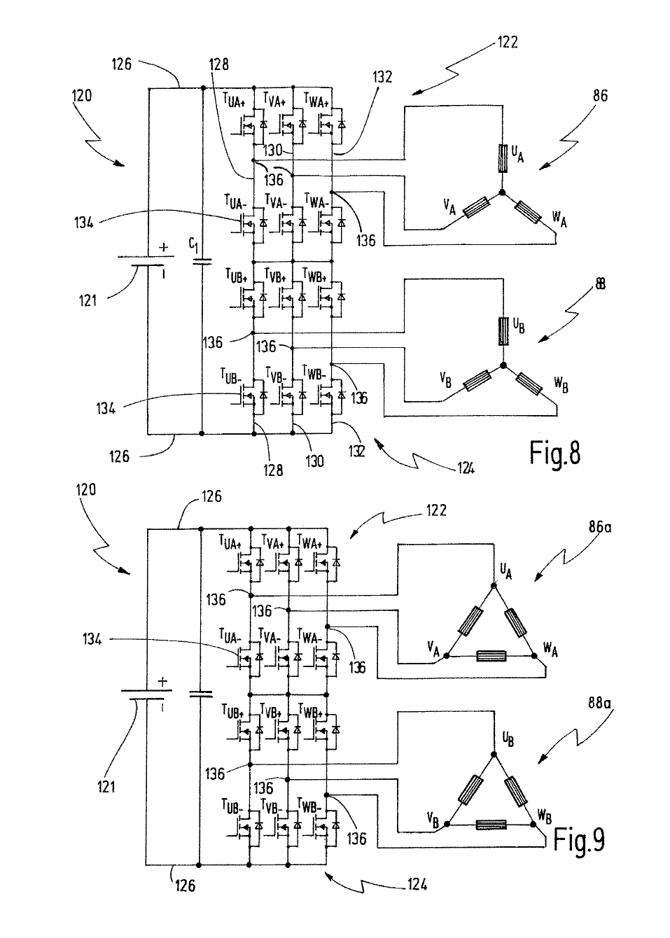

A circuit diagram of a control unit for actuating the first coil arrangement 86 and the second coil arrangement 88 is illustrated schematically in FIG. 8. The control unit is denoted in general in FIG. 8 by 120. The coil arrangements 86, 88 are illustrated schematically in FIG. 8 arranged in a star connection and are supplied with electrical power in three phases by the control unit 120. The control unit 120 has a voltage source 121, which in this case is formed as a battery or accumulator. The control unit 120 further has a first actuation arrangement 122 for actuating the first coil arrangement 86 and further a second actuation arrangement 124 for actuating the second coil arrangement 88,

The first and the second coil arrangement 122, 124 are constructed identically and are connected in series between voltage connections of the electric power supply 120. The control arrangements 122, 124 each have three parallel current paths 128, 130, 132, which are connected parallel to one another and each have two controllable switches 134. A tap 136 is formed between each of the controllable switches 134 and is connected accordingly to the lines 80, 84 to form one of the phases U, V, W, U′, V′, W′. The three parallel current paths 128, 130, 132 are electrically interconnected at their ends.

By opening two of the controllable switches 134 of one of the actuation arrangements in different current paths 128, 130, 132, two of the coil sets L₁, L₂, L₃ can be energized in each case, such that, by switching over the controllable switches 134, each of the previously mentioned energization states or commutation states can be produced. Provided two controllable switches in the same current path 128, 130, 132 are closed, the corresponding coil arrangement 86, 88 is not energized and thus generates no rotating field 94, 96.

Since the two actuation arrangements are connected in series between the voltage points 126, the same current in principle flows through the two coil arrangements 86, 88. In spite of switching over the rotating fields, the electrical resistance of the entire drive thus remains identical, whereby the power output of the drive 70 remains substantially the same for different switching states.

With the control unit 120, the basic state of the first coil arrangement 86 can be superimposed by a commutation sequence of the second coil arrangement 88, these coil arrangements being magnetically coupled via the iron core portions 77. If the second coil arrangement 88 is energized in the same sequence of commutation groups of the basic state, but in a different direction or polarity, which is directed oppositely to the basic state, a commutation sequence is produced that corresponds to a field weakening or EMF weakening.

The second coil arrangement 88 can be energized arbitrarily. An arbitrary commutation step of the second coil arrangement 88 can be combined with any of the six commutation steps of the first coil arrangement 86. On the whole, six multiplied by six total states are thus possible. Not all provide a sensible combination however, and some can be used however to generate further speed-torque characteristics of the overall coil system. By way of example, two commutation sequences are specified hereinafter. In these sequences, there is alternately a switchover between the basic state and the EMF-weakened state of the switchable coil portions or the additional coils 82.

The first and second actuation arrangement 90, 92 illustrated in FIG. 3 can each be formed by one of the control arrangements 122, 124 with in each case three current paths 128, 130, 132 and six controllable switches and in each case one voltage source.

In FIG. 9, an alternative circuit diagram of the coil arrangements 86, 88 from FIG. 8 is illustrated. Like elements are denoted by like reference numerals, wherein merely the differences are presented here. In FIG. 9, the coil arrangements 86a, 88a are arranged as a delta connection. The coil arrangements 86a, 88a are supplied in three phases via the phases U, V, W, U′, V′, W′, identically to FIG. 8, more specifically via the control unit 120.

In a further embodiment, one of the coil arrangements 86, 88, for example the first, can also be arranged in a star connection 86, and for example the second can be arranged in a delta connection, or vice versa.

In an alternative embodiment, the second coil arrangement 88 can be formed in such a way that the coil sets L₁′, L₂′, L₃′ can be energized independent of one another and separately. Further states of reverse polarity are thus possible, whereby the number of possible weakening factors can be further increased. It is also conceivable for the second coil arrangement 88 to have merely one individual coil set L₁′, L₂′, L₃′, which is associated with a corresponding coil set of the first coil arrangement 86. A simplified drive with field weakening can thus be provided, in which both the second coil arrangement 88 and the second actuation arrangement 124 is less complex in terms of construction.

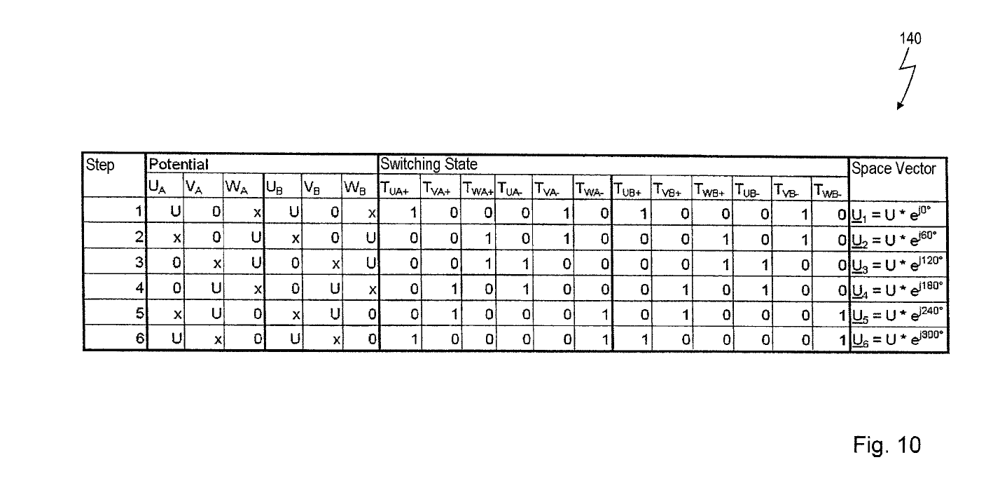

In FIG. 10, a table is illustrated that presents switching states of the controllable switches 134 for six different commutation steps with the reference signs from FIGS. 8 and 9 and is denoted generally by 140. The commutation steps generate rotating fields 94, 96 for normal operation. In other words, in the switching states illustrated in FIG. 10, the rotating fields 94, 96 are in principle directed in the same direction, such that the corresponding rotating fields 94, 96 intensify to form a total field. Here, the potentials at the connections U_{A}, V_{A}, W_{A} of the first coil system 86 and at the connections U_{B}, V_{B}, W_{B} of the second coil system 88 are denoted by U or zero for a high or low potential respectively and by X as an undefined or floating potential. The switching states are denoted by one for a closed switch and by zero for an open switch. Furthermore, the corresponding resultant voltage phasor is specified in polar form.

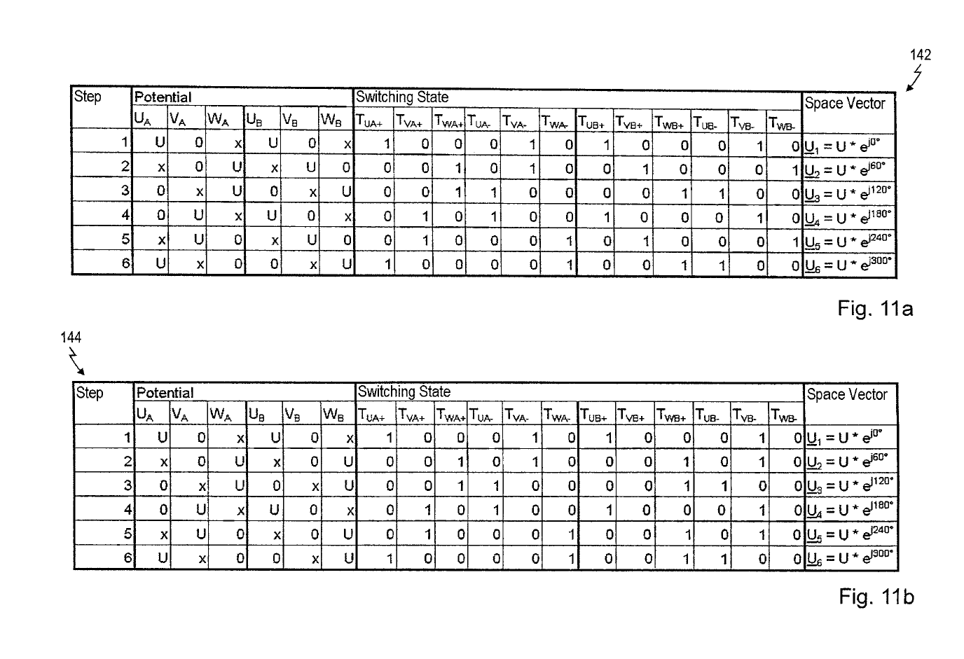

In FIGS. 11a and 11b, tables are illustrated that show switching states of the controllable switches 134 for six different commutation steps with the reference signs from FIGS. 8 and 9 for an exemplary field weakening operation in each case, said tables being denoted in general by 142 and 144 respectively. In table 142, switching states of the rotating fields 94, 96 for field weakening operation or EMF weakening operation are illustrated, wherein the polarity of the second coil arrangement is reversed in steps 2, 4 and 6 compared to the normal state or normal operation, and weakening operation or an EMF weakening is thus generated.

In table 144, further switching states for alternative weakening operation are illustrated. In the case of the commutation steps from table 144, the polarity of the second coil arrangement 80 in steps 4, 5 and 6 is reversed compared to normal operation, such that a corresponding field weakening operation is set. With this field weakening operation, an asymmetrical elliptical rotating field is produced.

What is claimed is:

1. An electric drive, in particular for a power tool, comprising a rotor, a stationary stator, and a first coil arrangement, which is designed to drive the rotor by means of a first rotating field, and comprising a first motor control arrangement, which is designed to supply the first coil arrangement with electric current in order to generate the first rotating field, wherein the electric drive has a second coil arrangement for generating a second rotating field, wherein the electric drive has a second motor control arrangement, which is designed to supply the second coil arrangement with electric current in order to generate the second rotating field, wherein the second coil arrangement is fixedly associated to the first coil arrangement and is magnetically coupled at least partially to the first coil arrangement, wherein the second coil arrangement can be actuated and energized separately from the first coil arrangement so as to actuate the second coil arrangement in an arbitrary commutation sequence, wherein the first motor control arrangement and the second motor control arrangement are designed to operate the motor with a first speed-torque characteristic and with a second speed-torque characteristic, which has a different gradient compared to the first speed-torque characteristic, and wherein the respective gradients of the speed-torque characteristics can be set in accordance with the direction of the first and of the second rotating field and/or in accordance with the sequence of the individual commutation steps.

2. An electric drive, in particular for a power tool, comprising a rotor, a stationary stator, and a first coil arrangement, which is designed to drive the rotor by means of a first rotating field, and comprising a first motor control arrangement, which is designed to supply the first coil arrangement with electric current in order to generate the first rotating field, wherein the electric drive has a second coil arrangement for generating a second rotating field, wherein the electric drive has a second motor control arrangement, which is designed to supply the second coil arrangement with electric current in order to generate the second rotating field, wherein the second coil arrangement is fixedly associated to the first coil arrangement and is magnetically coupled at least partially to the first coil arrangement, wherein the second coil arrangement can be actuated and energized separately from the first coil arrangement so as to actuate the second coil arrangement in an arbitrary commutation sequence.

3. The electric drive as claimed in claim 2, wherein the second coil arrangement can be energized in such a way that the second rotating field is directed oppositely at least partially to the first rotating field or the first and the second rotating field are at least partially directed in the same direction.

4. The electric drive as claimed in claim 2, wherein the first coil arrangement has a first plurality of coil sets and the second coil arrangement has a second plurality of coil sets, wherein at least one of the coil sets of the first coil arrangement is magnetically coupled to a coil set of the second coil arrangement.

5. The electric drive as claimed in claim 2, wherein the first and the second coil arrangement have an identical plurality of coil sets, which are each associated to one another and are each magnetically coupled to one another.

6. The electric drive as claimed in claim 4, wherein a plurality of coil sets of the first coil arrangement and a plurality of coil sets of the second coil arrangement can be energized simultaneously.

7. The electric drive as claimed in claim 6, wherein at least one coil set of the second coil arrangement can be energized, said coil set being associated to an unenergized coil set of the first coil arrangement.

8. The electric drive as claimed in claim 2, wherein the first coil arrangement can be energized with a first plurality of phases and the second coil arrangement can be energized with a second plurality of phases.

9. The electric drive as claimed in claim 8, wherein the first plurality of phases and the second plurality of phases are identical.

10. The electric drive as claimed in claim 8, wherein the first plurality of phases is greater than the second plurality of phases.

11. The electric drive as claimed in claim 2, wherein the first and the second coil arrangement each have three coil sets, which are each connected together in a star connection or in a delta connection or are arranged in a star-delta connection.

12. The electric drive as claimed in claim 2, wherein the drive is formed as an electronically commutatable D.C. machine, wherein the first and the second coil arrangement can be energized differently in a plurality of commutation steps.

13. The electric drive as claimed in claim 12, wherein the second coil arrangement can be energized in at least one of the commutation steps in such a way that the second rotating field is directed oppositely to the first rotating field.

14. The electric drive as claimed in claim 12, wherein the second coil arrangement can be energized in at least one of the commutation steps in such a way that the second rotating field is directed in the same direction as the first rotating field.

15. The electric drive as claimed in claim 2, wherein the second coil arrangement can be actuated separately and energized with electric current by a second motor control arrangement.

16. The electric drive as claimed in claim 2, wherein the first and the second coil arrangement can be energized by the same current.

17. The electric drive as claimed in claim 2, wherein the first motor control arrangement and the second motor control arrangement are designed to operate the motor with a first speed-torque characteristic and with a second speed-torque characteristic, which has a different gradient compared to the first speed-torque characteristic.

18. The electric drive as claimed in claim 17, wherein the respective gradients of the speed-torque characteristics can be set in accordance with the direction of the first and of the second rotating field and/or in accordance with the sequence of the individual commutation steps.

19. A power tool, characterized by a drive as claimed in claim 1, which can be coupled to a tool spindle to drive the tool.

20. A method for actuating an electric drive, in particular for a power tool, wherein the electric drive has a rotor and a stationary stator, wherein a first coil arrangement is supplied with electric current by a motor control in order to generate a first rotating field, wherein, by means of a second coil arrangement, which is fixedly associated with the first coil arrangement and is magnetically coupled at least partially to the first coil arrangement a second rotating field is generated, wherein the second coil arrangement is actuated and energized separately from the first coil arrangement.
